(19) United States
(12) Patent Application Publication
(10) Pub. No.: US 2026/0179897 A1
(43) Pub. Date: Jun. 25, 2026

(54) ELECTRODE ASSEMBLY FOR AN ION GUIDE AND METHOD OF FORMING AN ELECTRODE ASSEMBLY

(71) Applicant: Thermo Fischer Scientific (Bremen) GmbH, Bremen (DE)

(72) Inventors: Hamish Stewart, Bremen (DE); Alexander Wagner, Bremen (DE)

(21) Appl. No.: 19/413,695

(22) Filed: Dec. 9, 2025

(30) Foreign Application Priority Data
Dec. 19, 2024 (GB) GB2418698.3

(51) Int. Cl. H01J 49/06

(52) U.S. Cl. CPC H01J 49/063; H01J 49/068

(57) ABSTRACT

A method of forming an electrode assembly for an ion guide comprises: providing an alignment guide comprising a plurality of holes; providing a plurality of electrodes, each electrode of the plurality of electrodes being rotationally symmetrical about at least a first axis; arranging each electrode of the plurality of electrodes in a hole of the plurality of holes; and electrically connecting each electrode of the plurality of electrodes to a base. An electrode assembly for an ion guide comprises: an alignment guide comprising a plurality of holes; a plurality of electrodes, each electrode of the plurality of electrodes being rotationally symmetrical about at least one axis; and a base; wherein each electrode of the plurality of electrodes is electrically connected to the base; and each electrode of the plurality of electrodes is received in a hole of the plurality of holes.

The invention relates to an electrode assembly, an ion guide and methods of forming the same. More particularly, the electrode and ion guide may be for use in mass spectroscopy.

### BACKGROUND

Ion guides and traps commonly apply a combination of direct current (DC) and Radio frequency (RF) potentials to both constrain and manoeuvre ions as desired. While linear multipole ion guides that define ion guiding channels are common, stacked ring ion guides utilizing a series of alternating RF electrodes are also well understood. More complex ion guides, for example as required for beam switching devices, high capacity traps, and the long complex ion routes demanded by high resolution ion mobility devices, require expansion from a straight channel into at least a 2D plane.

Complex planar ion guides may be produced by printing electrodes onto Printed Circuit Board (PCB), allowing generation of large numbers (for example, hundreds) of discrete electrodes and their connections. An example of this type of ion guide is the folded path ion mobility used in Structure for Lossless Ion Manipulation (SLIM) ion guides (for example, as in U.S. Pat No. 8,835,839B1).

In a complex ion guide, a travelling wave may be used to propel the ions (for example, as in U.S. Pat. No. 6,794,641B2).

In PCB-printed ion guides, the insulating material of the PCB is arranged at the same distance to the trapped ions, and whatever charged droplets or other material may be accompanying them, as the electrode surfaces. They may therefore be prone to charging effects as ions and other charged particles strike these areas. Masking of electrode edges, a technique used to prevent electronic breakdowns, may make this problem worse by raising the insulator above the electrode surface. PCB ion optics are thus typically designed to minimise the insulating space between electrodes, or to ensure that such gaps are covered by strong ion-repelling RF fields. Another issue is RF heating, caused by the large contact surface between RF electrodes and the insulator.

Alternatively, solid metal electrodes may be affixed to a PCB substrate. This may allow electrodes proximate to ion populations to be raised up away from insulator, while more distant electrodes may still be safely PCB printed.

U.S. Pat. No. 953,672B2 discloses an ion guide for mass spectrometry comprising an electrode arrangement of at least two electrodes, at least one of which is an RF electrode, arranged adjacent to each other but spaced apart on a planar surface of a dielectric material and arranged at a distance from an ion flow path, wherein a portion of the dielectric surface is exposed between an adjacent pair of the spaced apart electrodes and wherein at least one electrode of said adjacent pair of electrodes is arranged to overhang the exposed portion of surface between them such that there is no direct line of sight from the ion flow path to the exposed portion of dielectric surface.

While known for small devices, for example the four solid RF electrodes of a small quadrupole ion guide, machining and assembly of dozens or hundreds of electrodes required for a complex ion path may be prohibitively expensive and failure-prone.

There is a need to provide low cost, accurately manufactured complex ion guides, while avoiding the issues of printed PCB electrode arrangements such as those discussed above. The electrode assembly and methods of the present disclosure seek provide a robust, simplified structure, with simplified repair and/or cleaning. The present disclosure also seeks to provide uniformly aligned electrodes positioned with high accuracy, thereby reducing the need for post-machining.

### SUMMARY

A first aspect of the present disclosure provides a method of forming an electrode assembly for an ion guide, the method comprising:
providing an alignment guide comprising a plurality of holes;
providing a plurality of electrodes;
arranging each electrode of the plurality of electrodes in a hole of the plurality of holes; and
electrically connecting each electrode of the plurality of electrodes to a base.

A second aspect of the present disclosure provides an electrode assembly for an ion guide, the electrode assembly comprising:
an alignment guide comprising a plurality of holes;
a plurality of electrodes; and
a base;
   wherein:
each electrode of the plurality of electrodes is electrically connected to the base; and
each electrode of the plurality of electrodes is received in a hole of the plurality of holes.

A further aspect of the present disclosure provides an electrode assembly for an ion guide, the electrode assembly comprising: a plurality of electrodes arranged in a planar array, each electrode of the plurality of electrodes being rotationally symmetrical about at least one axis; and a base;
wherein each electrode of the plurality of electrodes is electrically connected to the base.
A further aspect of the present disclosure provides an electrode assembly for an ion guide, the electrode assembly comprising a plurality of electrodes, each electrode of the plurality of electrodes being spherical.

A further aspect of the present disclosure provides a method of forming an ion guide, the method comprising: forming an electrode assembly using any method of the present disclosure; and arranging the electrode assembly opposite a second electrode assembly or a counter electrode.

A further aspect of the present disclosure provides an ion guide comprising a first electrode assembly as described herein and a second electrode assembly or a counter electrode.

### BRIEF DESCRIPTION OF THE DRAWINGS

Embodiments of the disclosure will now be described, by way of example only, with reference to the following in which:

FIG. 1 is a partial cross section through two electrodes of the electrode assembly according to a first embodiment;

FIG. 2 is a schematic diagram of the alignment guide for use in an electrode assembly according to the first embodiment;

FIG. 3 is a schematic diagram of the alignment guide of FIG. 2 with the plurality of electrodes arranged in the holes;

FIG. 4 is an exploded view of the electrode assembly according to the first embodiment, showing a single electrode for clarity;

FIG. 5 is a partial cross section through two electrodes of the electrode assembly according to a further embodiment;

FIG. 6 is a partial cross section through two electrodes of the electrode assembly according to a further embodiment;

FIG. 7 is a partial cross section through two electrodes of the electrode assembly according to a further embodiment;

FIG. 8 is a partial cross section through two electrodes of the electrode assembly according to a further embodiment;

FIG. 9 is a schematic diagram of the alignment guide for use in an electrode assembly according to a further embodiment;

FIG. 10 is a partial cross section through two electrodes of the electrode assembly comprising the alignment guide of FIG. 9;

FIG. 11 is an exploded view of an electrode assembly according to a further embodiment, showing a single row of the electrodes for clarity;

FIG. 12 is a schematic cross section through an ion guide comprising two electrode assemblies according to the first embodiment;

FIG. 13 is an exploded view of an ion guide according to a further embodiment;

FIG. 14 is a schematic diagram of an alignment guide according to a further embodiment with the plurality of electrodes arranged in the holes; and

FIG. 15 is a schematic diagram of an alignment guide according to a further embodiment with the plurality of electrodes arranged in the holes.

### DETAILLED DESCRIPTION

The present disclosure provides an electrode assembly for use in an ion guide, for example an ion guide for use in mass spectrometry. The following illustrated embodiments are described by way of example only and are non-limiting.

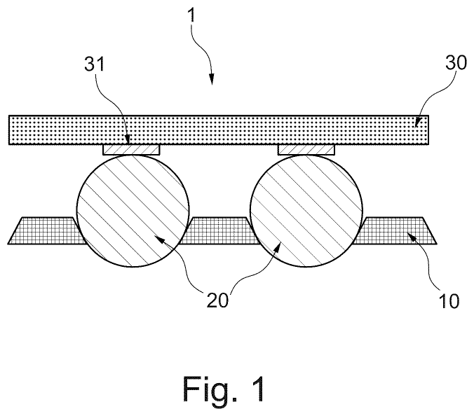

FIG. 1 shows a partial cross section of an electrode assembly 1 according to a first embodiment of the present disclosure. The electrode assembly 1 comprises an alignment guide 10, a plurality of electrodes 20 and a base 30.

Each electrode of the plurality of electrodes 20 is an electrically conductive (e.g. metal) electrode. Each electrode of the plurality of electrodes 20 may be rotationally symmetrical about at least one axis. The electrodes 20 of the first embodiment are spherical and therefore are continuously rotationally symmetrical about any axis. For example, the electrodes 20 may be ball bearings.

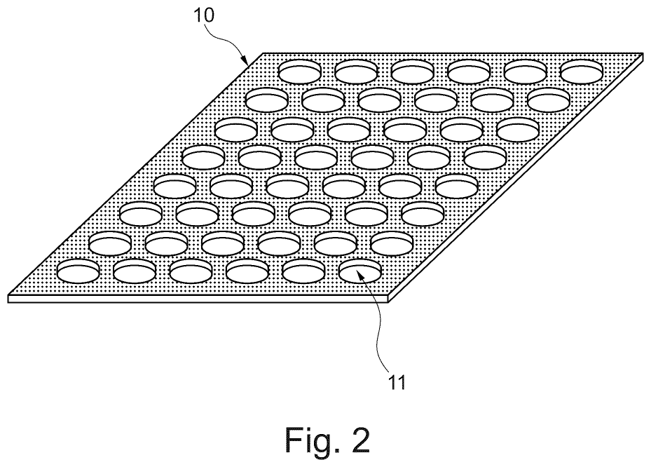

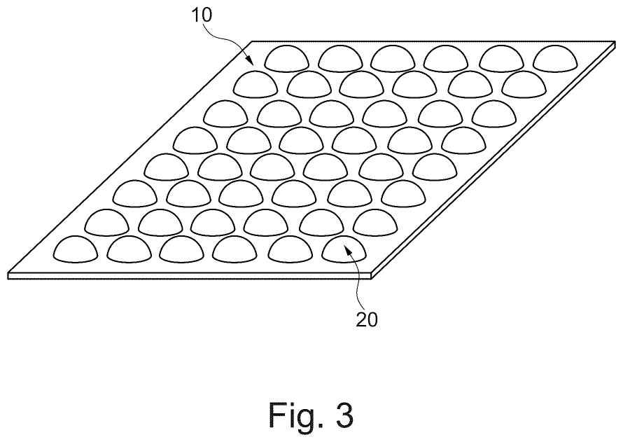

As best shown in FIGS. 2 and 3, in the first embodiment the alignment guide 10 is a planar plate in the form of a PCB. The alignment guide 10 comprises a plurality of holes 11. In the electrode assembly 1, each electrode of the plurality of electrodes 20 is received in a hole of the plurality of holes 11. The holes 11 are through-holes formed in the alignment guide 10. Each hole of the plurality of holes 11 is circular and the size of each hole is configured depending on the size of the electrode to be received therein, such that movement of the electrode in the plane of the alignment guide 10 is constrained or prevented when the electrode is arranged in the hole. As best shown in FIG. 1, the holes 11 are sized such that a minimum diameter of the hole is smaller than the diameter of the electrode received therein.

The plurality of holes 11 is configured in an orthogonal grid pattern (i.e. in rows in two orthogonal directions) to thereby align the electrodes 20 in rows. The plurality of electrodes 20 is arranged in a planar array, with a centroid of each electrode being arranged in a plane which is coplanar with or parallel to the plane of the alignment guide 10.

A rim of each hole of the plurality of holes 11 is chamfered (as best shown in FIG. 1), the widest diameter of the hole being arranged on a face of the alignment guide 10 arranged proximal to the base 30.

The alignment guide 10 and base 30 are arranged on opposite sides of the planar array of electrodes 20 such that a widest part (equator) of each electrode (as measured parallel to the plane of the array of electrodes) is positioned between the alignment guide 10 and the base 30, such that the electrodes 20 can be held in place by being clamped between the alignment guide 10 and the base 30. More particularly, the widest part (equator) of each electrode (as measured parallel to the plane of the array of electrodes) is positioned between a contact point between the alignment guide 10 and the electrode and a contact point between the electrode and the base 30.

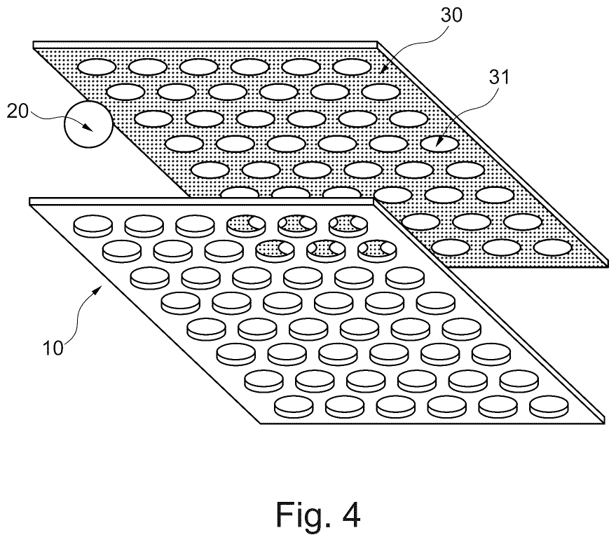

FIG. 4 is a schematic exploded view of the electrode assembly 1 according to the first embodiment, showing only a single electrode of the plurality of electrodes 20 for clarity. As illustrated in FIG. 4, in the electrode assembly 1 the plurality of electrodes 20 are sandwiched between the alignment guide 10 and the base 30 such that the clamping action of the alignment guide 10 and the base 30 holds the plurality of electrodes 20 in position to maintain an electrical connection between the plurality of electrodes 20 and the base 30.

Each electrode of the plurality of electrodes 20 is electrically connected to the base 30. In the first embodiment, the base 30 is a plate formed in the form of a printed circuit board (PCB). A plurality of contacts 31 are provided on the PCB for electrically connecting each one of the plurality of electrodes 20 to the base 30. The electrical contacts 31 are in the form of printed contacts on the PCB.

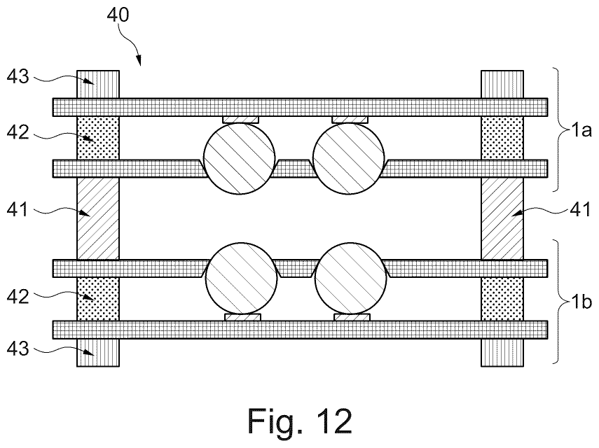

In use, the electrode assembly 1 may be arranged in the orientation shown in FIG. 1, or may be used in any other required orientation, for example in an inverted position as in the ion guide shown in FIG. 12.

The present disclosure also provides a method of forming an electrode assembly for an ion guide. The method comprises providing an alignment guide and a plurality of electrodes.

A second embodiment of the present disclosure provides a method of forming the alignment guide 1 of the first embodiment described above. The method comprises arranging each electrode of the plurality of electrodes 20 in a hole of the plurality of holes 11 of the alignment guide 11. The electrodes 20 are arranged in the plurality of holes 11 by placing them on the alignment guide 10 and causing the alignment guide and/or the electrodes to move such that the electrodes roll, slide or oscillate and thereby move into the holes, such that each hole of the plurality of holes 11 receives one electrode of the plurality of electrodes 20. By way of example, the alignment guide 10 may be tilted, shaken or oscillated to cause the electrodes to move into the holes. This movement may be facilitated by the chamfering of the rim of each hole on the face of the alignment guide over which the electrodes 20 are moved.

As best shown in FIG. 4, after the plurality of electrodes 20 are arranged in the plurality of holes 11, the base 30 is arranged opposite the alignment guide 10 such that each electrical contact 31 of the base 30 is aligned with a corresponding electrode of the plurality of electrodes 20. The base 30 and the alignment guide 10 are then moved together such that the plurality of electrodes 20 are clamped between the alignment guide 10 and the base 30. Each electrical contact 31 is thereby brought into contact with an electrode of the plurality of electrodes 20. The electrical connection of each electrode of the plurality of electrodes 20 to the base 30 is thereby established simultaneously.

The base 10 and alignment guide 30 may then be secured together using one or more of spacers, fasteners (e.g. nuts and bolts, mounting screws etc), frame components and/or other suitable components (as illustrated, for example, in FIG. 12).

The following describes electrode assemblies, ion guides and methods according to further exemplary embodiments of the present disclosure. Each of the following embodiments may be as described in the first and/or second embodiments except for the differences described below.

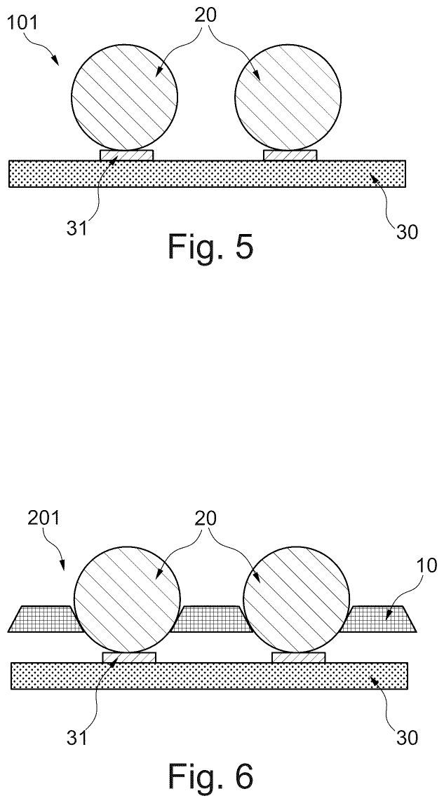

An electrode assembly 101 according to a further embodiment is shown in FIG. 5. In this embodiment, the plurality of electrodes 20 are not clamped between alignment guide 10 and the base 30. After arranging each electrode of the plurality of electrodes 20 in a hole of the plurality of holes 11 of the alignment guide 10, the electrical contacts 31 of the base 30 are brought into contact with the plurality of electrodes 20 as in the first embodiment. The plurality of electrodes 20 are then affixed to the base 30 and/or the electrical contacts 31, for example by soldering or adhesive. The alignment guide 10 may then be removed from the electrode assembly 1 before use, as shown in FIG. 5.

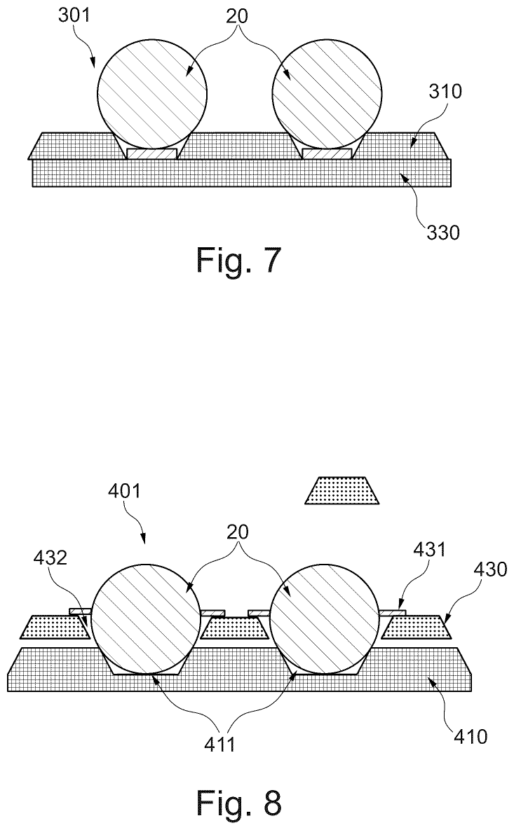

The electrode assembly 201 of the embodiment shown in FIG. 6 differs from the first embodiment in that the base 30 and the alignment guide 20 are arranged on a same side of the widest point of each electrode (as measured parallel to the plane of the array of electrodes) such that the widest part (equator) of the electrode is positioned on an opposite side of the alignment guide 10 to the base. The thickness of the alignment guide 10 is smaller than the radius of each electrode such that electrodes 20 protrude through the holes 11 towards the base 30 and are attached thereto, for example by soldering, adhesive or any other suitable method. The alignment guide 10 may be spaced apart from the base 30 in a direction perpendicular to the plane of the array of electrodes 20 as shown in FIG. 6 (for example, using one or more of spacers, fasteners (e.g. nuts and bolts, mounting screws etc), frame components and/or other suitable components). In a variation of this embodiment shown in FIG. 7, the alignment guide 310 of the electrode assembly 301 is unitary with or arranged in contact with the base 330. For example, the base 330 may be a PCB and the alignment guide 310 may be formed from an upper layer of the base 330.

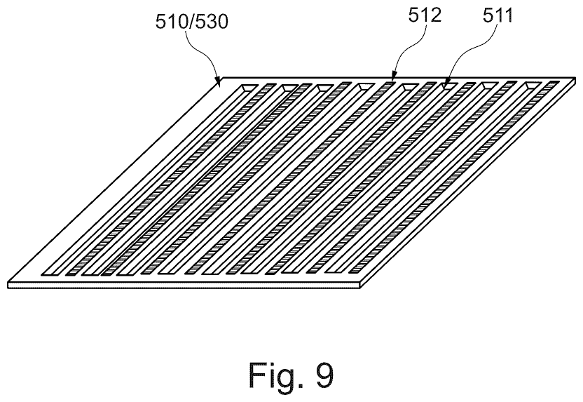

In the embodiment of FIG. 8, the electrode assembly 401 comprises an alignment guide 410 in the form of a plate, for example a metal plate. The plurality of holes 411 in the alignment guide 410 are blind holes (recesses) in the plate. The recesses have a depth which is less than the radius of the electrodes of the plurality of electrodes 20.

In this embodiment, the base 430 is a plate comprising a plurality of through holes 432. Each of the through holes 432 may be aligned with a hole 411 of the alignment guide 410. The size of each through hole 432 and thickness of the base 430 are configured based on the radius of the electrode 20 to be received therein such that at least a part of the electrode 20 protrudes from the base 430 when arranged in the hole 432. Therefore, at least during assembly of the electrode assembly 401, at least a part of the electrode 20 can be received in the aligned hole 411 of the alignment guide. The dimensions of each hole 411 of the alignment guide 410 are configured such that the hole 411 restricts movement of the electrode received therein to thereby define its position in the electrode assembly 401. A rim of each of the through holes 432 and/or the holes 411 of the alignment guide may be chamfered.

Electrical contacts 431 are formed by soldering each electrode of the plurality of electrodes 20 to a rim of the hole 432 in which it is received. The rim may be metallized. The soldered electrical contacts 431 may also secure the electrodes 20 to the base 30. Alternatively, the electrical contacts 431 may be formed by physical contact between the electrode 20 and the base 430 (for example, a metallised rim of a hole 432 of the base 430) and the electrode 20 may be secured in place by other means such as adhesive.

A method of forming the electrode assembly of FIG. 8 comprises arranging the base 430 parallel to the alignment guide 410 such that each through hole 432 of the base 430 is aligned with a corresponding hole 411 of the alignment guide 410. The base 430 may be in contact with the alignment guide 410 or may be spaced apart from the alignment guide 410 in a direction perpendicular to the plane of the alignment guide 410 (as shown in FIG. 8). The plurality of electrodes may then be arranged in the through holes 432 of the base 420 by placing them on the base 430 and causing the alignment guide 410, the base 430 and or the electrodes 20 to move such that the electrodes roll, slide or oscillate and thereby move into the through holes 432, and thereby into the holes 411 such that each hole of the plurality of holes 411 receives one electrode of the plurality of electrodes 20. Alternatively, the plurality of electrodes may be arranged in the through holes 432 of the base 430 before the base 430 is arranged parallel to the alignment guide, by placing them on the base 430 and causing the base 430 and/or the electrodes 20 to move such that the electrodes roll, slide or oscillate and thereby move into the through holes 432. The alignment guide 410 may then be arranged proximal to the base 410 and positioned such that each hole of the plurality of holes 411 receives one electrode of the plurality of electrodes 20.

The base 410 and alignment guide 430 may be secured together using one or more of spacers, fasteners (e.g. nuts and bolts, mounting screws etc), frame components and/or other suitable components. Alternatively, the alignment guide 410 may be removed after the electrodes 20 are secured to the base 430 such that in use the electrode assembly 401 comprises the plurality of electrodes 20 and the base 430 in the absence of the alignment guide 410. The alignment guide 410 may therefore be a reusable alignment jig. In such embodiments, the reusable alignment jig may be formed from metal.

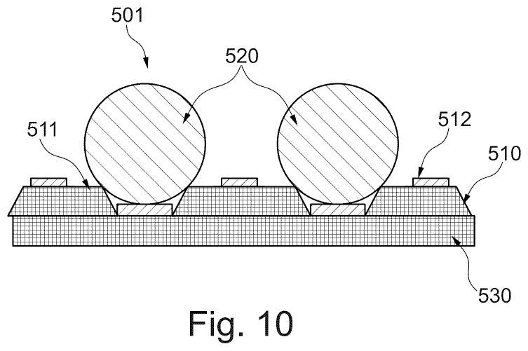

A unitary alignment guide 510 and base 530 for use in a further embodiment of the electrode assembly 501 is shown in FIG. 9. An electrode assembly 501 comprising the alignment guide 510 and base 530 is shown in FIG. 10. The alignment guide 510 and base 530 are formed from a PCB, the alignment guide 510 being an upper layer of the PCB.

This embodiment also differs from the first embodiment and that of FIG. 7 in that the electrodes 520 are cylindrical. For example, the electrodes 520 may be roller bearings. In this embodiment, the holes 511 of the alignment guide 510 are rectangular slots. The plurality of holes 511 are arranged in a parallel configuration such that, when the electrodes 520 are arranged in the holes, the longitudinal axis of each electrode is parallel to the longitudinal axis of each other electrode of the plurality of electrodes 520. The plurality of electrodes 520 are arranged in a planar array, with a centroid and the longitudinal axis of each electrode being arranged in a plane which is coplanar with or parallel to the plane of the alignment guide 510.

In the embodiment of FIG. 9, elongate auxiliary DC electrodes 512 are printed on the PCB, between the holes 511. The auxiliary DC electrodes are therefore positioned between the cylindrical electrodes 520 when they are mounted in the holes 511. In use, a DC gradient or travelling waves (e.g. low frequency travelling waves) may be applied using the auxiliary DC electrodes to move ions across the RF surface of the electrode assembly.

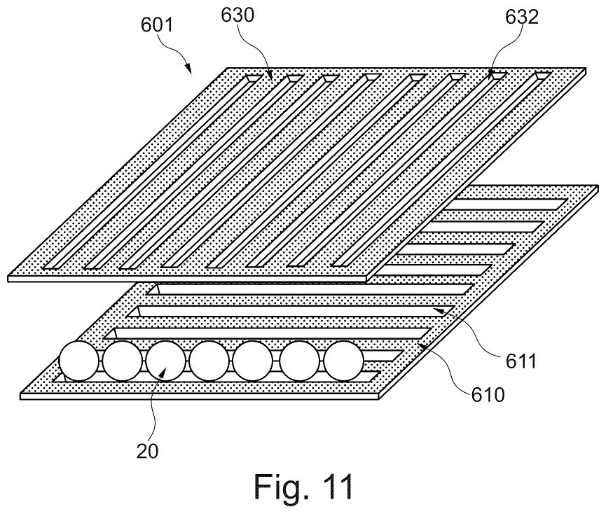

The embodiment of FIG. 11 comprises a first alignment guide 610 and base 630 and a plurality of spherical electrodes 20. In this embodiment, each hole of the plurality of holes 611 of the alignment guide 610 is a rectangular slot or trench. The base 630 also comprises a plurality of holes 632, each hole being a rectangular slot or trench. The plurality of holes 611 of the alignment guide 610 is arranged in a first parallel configuration. The plurality of holes 632 of the base 630 is arranged in a second parallel configuration. Each hole of each plurality of holes 611, 632 is sized to receive a single electrode of the plurality of electrodes 20 across its width and a plurality of electrodes along its length (i.e. along the elongate length of the hole). In the electrode assembly 601, the alignment guide 610 and the base 630 are arranged in parallel planes and are spaced apart to receive the plurality of electrodes 20 therebetween. The alignment guide 610 and the base 630 are arranged such that the elongate axes of the holes 611 on the alignment guide 610 are perpendicular to the elongate axes of the holes 632 on the base 630. The plurality of holes 611 of the alignment guide 610 are therefore configured to align the plurality of electrodes 20 in a first direction and the plurality of holes 632 of the base 630 are configured align the plurality of electrodes 20 in a second direction, the second direction being perpendicular to the first direction.

In the electrode assembly 601, the plurality of electrodes are clamped between the alignment guide 610 and the base 630.

Any electrode assembly of the present disclosure may be used to form one layer of an ion guide to the plurality of electrodes defining a radiofrequency (RF) surface of the ion guide. The embodiment illustrated in FIG. 12 is an ion guide 40 comprising a first electrode assembly 1a and a second electrode assembly 1b, each of the electrode assemblies 1a, 1b, being as described in the first embodiment.

The first electrode assembly 1a and second electrode assembly 1b are arranged parallel to each other such that they are spaced apart in a direction perpendicular to the planes of their arrays of electrodes. The second electrode assembly 1b is inverted relative to the first electrode assembly 1a. The spacing between the top and bottom electrodes may be greater than or equal to 2 mm, for example. Optionally, the spacing may be less than or equal to 10 mm, e.g. to allow focussing of ion distributions to downstream apertures.

One or more guard electrodes 41 are arranged between the alignment guides 10 of the first and second electrode assemblies 1a, 1b. Each of the one or more guard electrodes 41 may be provided proximal to an edge of the ion guide to thereby prevent or inhibit ion loss through the sides of the ion guide. Optionally, the guard electrode(s) may also act as spacers to define the relative positions of the first and second electrode assemblies 1a, 1b.

The first electrode assembly 1a and second electrode assembly 1b and/or guard electrode(s) 41 are fixed in place using a plurality of spacers 42 and fasteners 43.

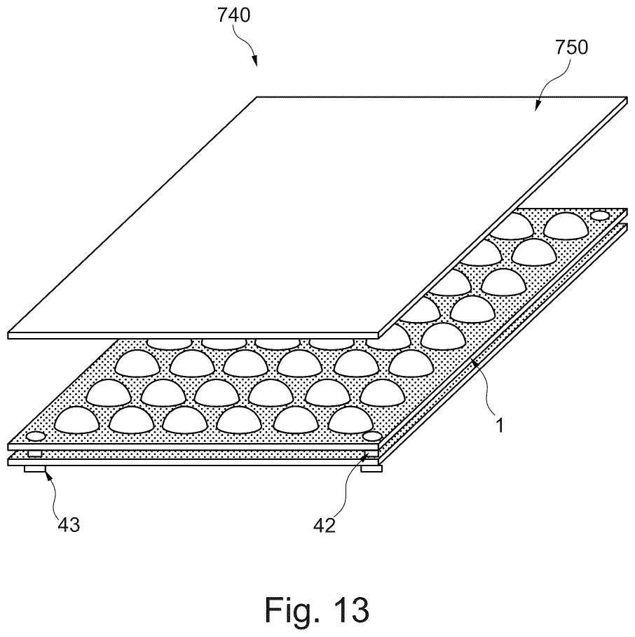

The embodiment of FIG. 13 is an exploded view of a further ion guide 740 comprising a first electrode assembly 1 as described in the first embodiment. The ion guide 740 also comprises a counter electrode 750 in the form of an electrically conductive (e.g. metal) plate.

The counter electrode 750 and electrode assembly 1 are arranged opposite each other and parallel to each other such that they are spaced apart in a direction perpendicular to the plane of the array of electrodes. The electrode assembly 1, counter electrode 750 and/or any guard electrode(s) are fixed in place using a plurality of spacers 42 and fasteners 43.

In use, a DC potential may be applied by the counter electrode 750 to pin ions down onto the RF surface formed by the array of electrodes 20 of the electrode assembly 1.

In a variation of this embodiment, an upper PCB comprising a plurality of electrodes may be provided in place of the counter electrode 750. In such embodiments, in use, an axial DC gradient or travelling wave of voltage may be applied using the upper PCB.

In use, focussing of the ion distribution in an ion guide according to the present disclosure may be performed by application of wedged DC or RF potentials. For example, these may be applied by applying a DC offset to a subset of the electrodes, the subset being arranged in a diagonal line relative to the ion flow path defined by the ion guide.

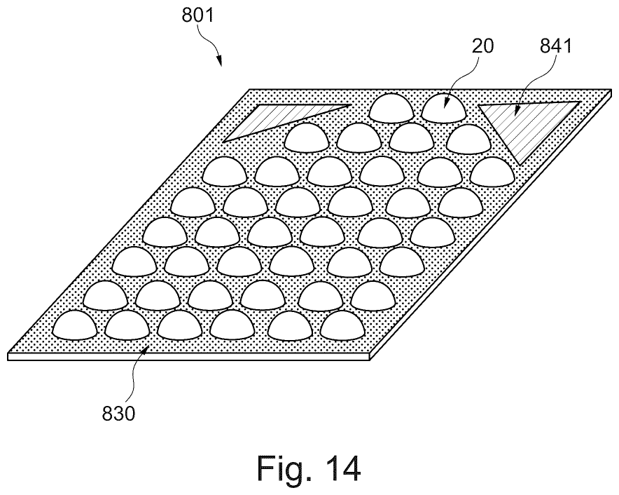

FIG. 14 shows an electrode assembly 801 according to a further variation of the first embodiment. The electrode assembly 801 comprises one or more wedge or triangular shaped guard electrodes 841 provided on the base 830. For example, the guard electrodes 841 may be printed or mounted on the base 830. The base 830 may be formed from a PCB.

To provide height compression of ions, the spacing or size of the electrodes 20 may be configured to control the depth of penetration of the RF surface into the ion guide volume. The size or spacing of the electrodes may increase along a length of the ion guide, either gradually or in one or more steps. Alternatively, or in addition, an ion funnel or interface part may be added to the ion guide.

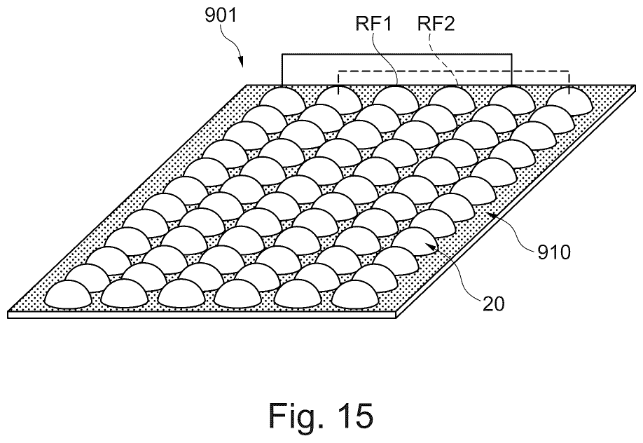

FIG. 15 shows an electrode assembly 901 according to a yet further variation of the first embodiment. In this embodiment, the plurality of holes in the alignment guide 910 are configured in an orthogonal grid pattern (i.e. in rows in two orthogonal directions) to thereby align the electrodes 20 in corresponding rows. A first RF voltage RF1 may be applied to a first set of alternate rows of the electrodes, and a second RF voltage may be applied to a second set of rows of the electrodes. The second RF voltage may correspond to the first RF voltage but may have the opposite phase.

Each electrode 20 may be arranged in contact with one or more adjacent electrodes in the same row, to form an electrical connection between them. In such embodiments, the number of electrical contacts provided on the base may be smaller than the number of electrodes.

Further aspects of the present disclosure are set out in the following numbered clauses:
A1. A method of forming an electrode assembly for an ion guide, the method comprising:
   providing an alignment guide comprising a plurality of holes;
   providing a plurality of electrodes;
   arranging each electrode of the plurality of electrodes in a hole of the plurality of holes; and
   electrically connecting each electrode of the plurality of electrodes to a base.
A2. The method of clause A1 wherein each electrode of the plurality of electrodes is rotationally symmetrical about at least a first axis.
A3.The method of clause A2 wherein each electrode of the plurality of electrodes is spherical or cylindrical.
A4. The method of any preceding clause wherein the base is a plate, wherein optionally:
   the base is planar; and/or
   the base is a printed circuit board (PCB).
A5. The method of any preceding clause wherein the alignment guide is one or more of:
   a plate, optionally a metal plate:
   a planar element;
   a printed circuit board (PCB); and/or
   a layer of a printed circuit board (PCB).
A6. The method of any preceding clause wherein arranging each electrode of the plurality of electrodes comprises causing the electrode to roll, slide or oscillate such that the electrode moves into the hole of the plurality of holes;
wherein optionally the electrode is caused to move, slide or oscillate over a surface of the alignment guide or of the base.
A7. The method of any preceding clause wherein electrically connecting each electrode of the plurality of electrodes to the base is carried out simultaneously;
   wherein optionally electrically connecting each electrode of the plurality of electrodes to the base comprises clamping the electrodes between the alignment guide and the base.
A8. The method of any preceding clause wherein electrically connecting each electrode of the plurality of electrodes to the base comprises soldering the electrode to the base.
A9. The method of any preceding clause wherein each hole of the plurality of holes receives a single electrode of the plurality of electrodes.
A10. The method of any of clauses A1 to A8 wherein each hole of the plurality of holes receives more than one electrode of the plurality of electrodes, the plurality of holes being configured to align the plurality of electrodes in a first direction;
   wherein the method optionally further comprises providing a further alignment guide configured to align the plurality of electrodes in a second direction, the second direction being perpendicular to the first direction, the base optionally comprising the further alignment guide.
A11. The method of any preceding clause wherein:
   the plurality of electrodes are arranged in a planar array.
A12. The method of any preceding clause further comprising removing the alignment guide after electrically connecting each electrode of the plurality of electrodes to the base.
A13. An electrode assembly for an ion guide, the electrode assembly comprising:
   an alignment guide comprising a plurality of holes;
   a plurality of electrodes; and
   a base;
wherein:
   each electrode of the plurality of electrodes is electrically connected to the base; and
   each electrode of the plurality of electrodes is received in a hole of the plurality of holes.
A14. The electrode assembly of clause A13 wherein each hole of the plurality of holes is configured to locate the electrode or electrodes received therein in at least a first direction.
A15. The electrode assembly of any one of clauses A13 to A14 wherein the base is planar, wherein optionally:
   the base is a plate; and/or
   the base is a printed circuit board (PCB).
A16. The electrode assembly of any one of clauses A13 to A15, wherein the base comprises a plurality of electrical contacts for electrically connecting the plurality of electrodes to the base;
   wherein optionally he electrical contacts are formed by soldering, adhesive, a sprung contact, clamping or welding.
A17. The electrode assembly of any one of clauses A13 to A16 wherein the alignment guide is one or more of:
   a plate, optionally a metal plate:
   a planar element;
   a printed circuit board (PCB); and/or
   a layer of a printed circuit board (PCB).
A18. The electrode assembly of any one of clauses A13 to A17 wherein the plurality of electrodes are arranged in a planar array.
A19. The electrode assembly of any one of clauses A13 to A18 wherein each hole of the plurality of holes is configured to align the electrode or electrodes received therein in a first direction;
   wherein the electrode assembly optionally further comprises a further alignment guide configured to align the electrode or electrodes received therein in a second direction, the second direction being perpendicular to the first direction, the base optionally comprising the further alignment guide.
A20. The electrode assembly of any one of clauses A13 to A19 wherein:
   each hole of the plurality of holes is a circular hole or a slot; and/or
   a rim of each hole of the plurality of holes is chamfered, stepped and/or countersunk; and/or
   each hole of the plurality of holes is an aperture or a recess; and/or
   the plurality of holes is configured to align the electrodes in an offset grid array or in an orthogonal grid array.
A21. The electrode assembly of any one of clauses A13 to A20 wherein the base comprises a plurality of holes, wherein each electrode of the plurality of electrodes is received in a hole of the plurality of holes of the base;
   wherein optionally each of the plurality of holes of the base is an aperture or a recess.
A22. The electrode assembly of any one of clauses A13 to A21 wherein each electrode of the plurality of electrodes is rotationally symmetrical about at least one axis; and
   wherein optionally each electrode of the plurality of electrodes is continuously rotationally symmetrical or has a minimum order of rotational symmetry of 4.
A23. The electrode assembly of any one of clauses A13 to A22 wherein the alignment guide and the base are arranged on opposite sides of the plurality of electrodes, the plurality of electrodes being clamped between the alignment guide and the base.
A24. The electrode assembly of any one of clauses A13 to A23 wherein the alignment guide and/or base are configured such that at least part of each electrode protrudes from the alignment guide and/or base in a direction towards an ion channel at least partially defined by the electrode assembly.
A25. The electrode assembly of clause A24 wherein one or more of
   a thickness of the alignment guide and/or base;
   dimensions of the holes of the plurality of holes of the alignment guide and/or base; and/or
   dimensions of a chamfer or recess of the holes of the plurality of holes of the alignment guide and/or base;
are configured based on the dimensions of the plurality of electrodes such that at least part of each electrode protrudes from the alignment guide and/or base;
B1. An electrode assembly for an ion guide, the electrode assembly comprising:
   a plurality of electrodes arranged in a planar array, each electrode of the plurality of electrodes being rotationally symmetrical about at least one axis; and
   a base;
      wherein each electrode of the plurality of electrodes is electrically connected to the base.
B2. The electrode assembly of clause B1 wherein each electrode of the plurality of electrodes is continuously rotationally symmetrical or has a minimum order of rotational symmetry of 4.
B3. The electrode assembly of any one of clause B1 or clause B2 wherein each electrode of the plurality of electrodes is spherical, wherein optionally the plurality of electrodes are ball bearings.
B4. The electrode assembly of any one of clause B1 or clause B2 wherein each electrode of the plurality of electrodes is cylindrical, wherein optionally the plurality of electrodes are cylindrical bearings.
B5. The electrode assembly of any one of clauses B1 to B4 wherein the plurality of electrodes are electrically connected to the base by soldering, glue, a sprung contact, clamping or welding.
B6. The electrode assembly any one of clauses B1 to B5 wherein the electrode assembly comprises a base, wherein the base is planar, and wherein optionally:
the base is a plate; and/or
the base is a printed circuit board (PCB).
B7. The electrode assembly of clause B6 wherein the base comprises a plurality of holes, wherein each electrode of the plurality of electrodes is received in a hole of the plurality of holes, wherein each of the plurality of holes of the base is an aperture or a recess.
B8. The electrode assembly any one of clauses B1 to B7 wherein the base comprises a plurality of electrical contacts for electrically connecting the plurality of electrodes to the base;
   wherein optionally the electrical contacts are formed by soldering, adhesive, a sprung contact, clamping or welding.
B9. The electrode assembly of any one of clauses B1 to B8 further comprising an alignment guide comprising a plurality of holes, wherein each electrode of the plurality of electrodes is received in a hole of the plurality of holes.
B10. The electrode assembly of clause B9 wherein each hole of the plurality of holes of the alignment guide is an aperture or a recess.
B11. The electrode assembly of clause B9 or clause BC10 wherein the alignment guide is one or more of:
   a plate, optionally a metal plate:
   a planar element;
   a printed circuit board (PCB); and/or
   a layer of a printed circuit board (PCB).
B12. The electrode assembly of any one of clauses B1 to B11 wherein each electrode of the plurality of electrodes comprises a metallic material, wherein the material is optionally stainless steel or copper.
   B13. The electrode assembly of any one of clauses B1 to B13 wherein the alignment guide and/or base are configured such that at least part of each electrode protrudes from the alignment guide and/or base in a direction towards an ion channel at least partially defined by the electrode assembly.
B14. The electrode assembly of clause B13 wherein one or more of
   a thickness of the alignment guide and/or base;
   dimensions of the holes of the plurality of holes of the alignment guide and/or base; and/or
   dimensions of a chamfer or recess of the holes of the plurality of holes of the alignment guide and/or base;
are configured based on the dimensions of the plurality of electrodes such that at least part of each electrode protrudes from the alignment guide and/or base.
C1. An electrode assembly for an ion guide, the electrode assembly comprising a plurality of electrodes, each electrode of the plurality of electrodes being spherical.
C2. the electrode assembly of clause c1 wherein the plurality of electrodes are arranged in a planar array.
C3. The electrode assembly of clause C1 or clause C2, wherein the plurality of electrodes are ball bearings.
C4. The electrode assembly of any one of clauses C1 to C3 further comprising a base, wherein each electrode of the plurality of electrodes is electrically connected to the base.
C5. The electrode assembly of clause C4 wherein the plurality of electrodes is electrically connected to the base by soldering, glue, a sprung contact, clamping or welding.
C6. The electrode assembly any one of clauses C1 to C5 wherein the electrode assembly comprises a base, wherein the base is planar, and wherein optionally:
   the base is a plate; and/or
   the base is a printed circuit board (PCB).
C7. The electrode assembly of clause B6 wherein the base comprises a plurality of holes, wherein each electrode of the plurality of electrodes is received in a hole of the plurality of holes, wherein each of the plurality of holes of the base is an aperture or a recess.
C8. The electrode assembly any one of clauses C1 to C7 wherein the base comprises a plurality of electrical contacts for electrically connecting the plurality of electrodes to the base;
   wherein optionally the electrical contacts are formed by soldering, adhesive, a sprung contact, clamping or welding.
C9. The electrode assembly of any one of clauses C1 to C8 further comprising an alignment guide comprising a plurality of holes, wherein each electrode of the plurality of electrodes is received in a hole of the plurality of holes.
C10. The electrode assembly of clause C9 wherein each hole of the plurality of holes of the alignment guide is an aperture or a recess.
C11. The electrode assembly of clause c9 or clause c10 wherein the alignment guide is one or more of:
   a plate, optionally a metal plate:
   a planar element;
   a printed circuit board (PCB); and/or
   a layer of a printed circuit board (PCB).
C12. The electrode assembly of any one of clauses C1 to C11 wherein each electrode of the plurality of electrodes comprises a metallic material, wherein the material is optionally stainless steel or copper.
C13. The electrode assembly of any one of clauses C1 to C12 wherein the alignment guide and/or base are configured such that at least part of each electrode protrudes from the alignment guide and/or base in a direction towards an ion channel at least partially defined by the electrode assembly.
C14. The electrode assembly of clause C13 wherein one or more of
   a thickness of the alignment guide and/or base;
   dimensions of the holes of the plurality of holes of the alignment guide and/or base; and/or
   dimensions of a chamfer or recess of the holes of the plurality of holes of the alignment guide and/or base;
are configured based on the dimensions of the plurality of electrodes such that at least part of each electrode protrudes from the alignment guide and/or base.
D1. A method of forming an electrode assembly according to any of clauses B1 to B14 or C1 to C14, the method comprising arranging the plurality of electrodes in a planar array using an alignment guide.
D2. The method of clause D1 further comprising forming the electrode assembly using the method of any of clauses A1 to A12.
E1. A method of forming an ion guide, the method comprising:
   forming an electrode assembly using the method of any one of clauses A13 to A25, B1 to B14 or C1 to C14; and
   arranging the electrode assembly opposite a second electrode assembly or a counter electrode.
E2. The method of clause E1 wherein the second electrode assembly is formed using the method of any of clauses A1 to A12 or D1 to D2.
E3. The method of clause e1 or e2 wherein the ion guide is a planar ion guide.
F1. An ion guide comprising
   a first electrode assembly as in any one of clauses A13 to A25, B1 to B14 or C1 to C14; and
   a second electrode assembly or a counter electrode.
F2. The ion guide of clause F1 wherein the second electrode assembly is in any of clauses A13 to A25, B1 to B14 or C1 to C14.
F3. The ion guide of clause F1 or F2 wherein the ion guide is a planar ion guide.

While embodiments of the present disclosure have been described above and illustrated in the drawings, these are for example only and are non-limiting. It will be appreciated by those skilled in the art that alternatives are possible within the ambit of the disclosure. For example, features described in the context of the disclosed methods may also be applied to the disclosed apparatus, and vice versa. Any embodiment according to the present disclosure may comprise any technically feasible combination of the features below.

As used herein, the term “equator” is used to refer to a widest part of the electrode in the rotationally symmetrical cross section of the electrode, measured in a direction parallel to the plane of the alignment guide. For a spherical electrode, this may be the diameter of the electrode as measured parallel to the plane of the alignment guide. For a cylindrical electrode, this may be the diameter of the circular cross section of the electrode as measured parallel to the plane of the alignment guide. The terms “radius” and “diameter” are used to refer to dimensions measured across the rotationally symmetrical cross section of the electrodes.

### Base

In the illustrated embodiments, the base is a PCB. In any embodiment, the base may be a plate, a planar plate or a PCB, and/or may be formed from any insulating material (for example, plastic or ceramic).

In any embodiment, the base may comprise a plurality of electrical contacts for electrically connecting the plurality of electrodes to the base. The electrical contacts may be formed, for example, by soldering, glue, a sprung contact, clamping or welding. In embodiments where the base is a PCB, the electrical contacts may be printed contacts on the PCB. The electrical contacts may be arranged in an array in which the position of each contact matches the position of a corresponding electrode of the plurality electrodes. The electrical contacts may be formed by soldering and/or may comprise contact pads and/or spring contacts. The electrodes may be held in place in/on the base and/or alignment guide by solder, adhesive or mechanical attachments. In embodiments in which the base is not a PCB, the base may further comprise wires or other conducting elements may be provided to form the electrical connections to the electrodes. One electrical contact may be provided for each electrode. Alternatively, each electrode may be arranged in contact with one or more adjacent electrodes, to form an electrical connection between them. In such embodiments, the number of electrical contacts provided on the base may be smaller than the number of electrodes. For example, a single electrical contact may be provided for each row of electrodes. Arranging the electrodes in contact may also provide a clamping force between the electrodes which may facilitate assembly of the electrode assembly or an ion guide comprising the electrode assembly.

In any embodiment, the plurality of electrodes may be attached to the base by clamping, for example between the alignment guide and the base or using other clamping components. Alternatively or additionally, the plurality of electrodes may be attached to the base by soldering, adhering, welding, spot-welding, or using other mechanical attachment elements, for example clips, fasteners or sprung components (optionally, sprung electrical contacts).

In any embodiment, the base may comprise a plurality of holes for receiving the plurality of electrodes. These holes may be through holes or recesses in the base. The rim of each hole may be chamfered or otherwise recessed, for example the rim may be countersunk and/or stepped. One or more of the holes may comprise the electrical contacts for electrically connecting one or more of
the plurality of electrodes to the base. The holes of the base may be arranged such that in use each hole is aligned with one or more holes of the alignment guide. Each hole in the base may be in the form of a through hole (i.e. an aperture) or a blind hole (i.e. a recess). In any embodiment, a rim of the or each hole of the base may be metallised to form an electrical connection between the electrode and the base. Each hole of the base may be circular or square. Alternatively, each hole of the base may be a slot or trench, optionally a rectangular slot or trench.

In embodiments in which the holes of the base are through holes. the size of each through hole and thickness of the base may be configured based on the radius (or widest dimension of the rotationally symmetrical cross section) of the electrode received therein, such that at least a part of the electrode protrudes from the base when received in the hole and can be received in the aligned hole of the alignment guide. In embodiments in which the holes are recesses, each recess may have a depth smaller than a radius (or widest dimension of the rotationally symmetrical cross section) of the electrode received therein.

In any embodiment, one or more wedge or triangular shaped guard electrodes may be provided on the base or the alignment guide. For example, the guard electrodes may be printed or mounted on the base or the alignment guide. To provide height compression of ions, the spacing or size of the electrodes may be configured to cause the RF surface to penetrate deeper into the ion guide volume. The size or spacing of the electrodes may increase along a length of

the ion guide, either gradually or in one or more steps.

### Electrodes

According to the present disclosure, each electrode of the plurality of electrodes is rotationally symmetrical about at least one axis. Each electrode may consist of a body that is rotationally symmetric about at least one axis (e.g. spherical or cylindrical). Each hole of the alignment guide and/or base may be shaped and sized to receive the body. The body may be directly received in each hole (such that the body is in direct contact with a periphery of the hole).

In any embodiment, each electrode of the plurality of electrodes may be identical to each other electrode of the plurality of electrodes.

In any embodiment, the electrodes may be formed from pre-fabricated components such as bearings, for example ball bearings or roller bearings. The present disclosure may thereby achieve accurate manufacturing tolerances at low cost.

In any embodiment, each electrode of the plurality of electrodes may be rotationally symmetrical about at least one axis. The at least one axis may be an axis arranged in a plane which is coplanar or parallel to the plane of the alignment guide or of the planar base. The at least one axis may be arranged in the plane of the planar array of electrodes. Each electrode of the plurality of electrodes may be continuously rotationally symmetrical about the at least one axis (e.g. it may have at least one continuously rotationally symmetrical cross section, for example perpendicular to the plane of the array of electrodes and/or the plane of the alignment guide) or have a minimum order of rotational symmetry of 4 or 6 about the at least one axis. The shape and order of symmetry of the electrode may be selected such that when arranged in the electrode assembly the portion of each electrode extending into the ion channel is consistent with that of each other electrode. Each electrode of the plurality of electrodes may be spherical (for example, in the form of ball bearings). Alternatively, each electrode of the plurality of electrodes may be cylindrical (for example, in the form of roller bearings). The present disclosure may therefore allow for the use of accurately manufactured low cost standard parts, for example bearings, such as ball bearings and/or facilitate accurate positioning of electrodes.

By using electrodes having a smooth surface curvature (such as spherical or cylindrical bearings) the risk of voltage discharge, exacerbated by high electrical field strength around sharp edges, may be minimised.

In any embodiment, the plurality of electrodes within the electrode assembly may be arranged in a planar array. For example, each electrode may be arranged with its centroid in the plane of the planar array, the plane of the planar array optionally being coplanar with or parallel to the plane of the alignment guide or of the planar base of the electrode assembly. The centroid may be defined as the geometric centre of the electrode. Where the electrodes have a longitudinal axis (for example, for cylindrical electrodes), each electrode may be arranged with its centroid and/or longitudinal axis arranged in the plane of the planar array, the plane of the planar array optionally being coplanar with or parallel to the plane of the alignment guide or of the planar base of the electrode assembly. The cylindrical electrodes may optionally be arranged such that the longitudinal axes of the cylindrical electrodes are parallel to each other.

In any electrode assembly according to the present disclosure, the plane of the planar alignment guide (where present), the plane of the planar array of electrodes and/or the plane of the planar base may be arranged parallel to each other.

In any embodiment, each electrode of the plurality of electrodes may comprise a metallic material, wherein the material is optionally stainless steel or copper. The electrodes may be formed as solid monoliths or may be coated. The use of stainless steel may provide hard, contamination resistant bearings at low cost. Copper or coated bearings may be used in embodiments using soldering for fixing or electrically connecting the electrodes.

By providing an alignment guide or base with an array of holes to in which to locate the electrodes and a plurality of electrodes with rotational symmetry, the present disclosure may facilitate the accurate positioning of the electrodes, as they can be rolled into the holes, especially if the holes are chamfered or otherwise recessed, so that locating large numbers of electrodes within the electrode assembly may be a simplified and more economical process.

### Alignment Guide

In the illustrated embodiments, the alignment guide is a planar PCB. In any embodiment, the alignment guide may be a plate (optionally a metal plate), a planar element, a printed circuit board (PCB) and/or a layer of a printed circuit board (PCB). The alignment guide may be formed from an insulating material, for example an engineering plastic such as PEEK, or ceramic. The material of the alignment guide may be selected to be sufficiently stiff and strong to maintain the shape of the alignment guide in use to thereby improve accuracy of electrode positioning, and to avoid breakage of the alignment guide, for example when clamped in an electrode assembly or ion guide. The use of the alignment guide may allow for improved accuracy of positioning the electrodes, for example if the alignment plate is produced from metal such as steel, which can be cut more accurately than PCB or plastic materials.

In any embodiment, the planar alignment guide may be curved, for use in curved ion guides or collision cells. Alternatively, or additionally, the array of holes of the alignment guide may be configured to position the electrodes in a curved planar array, or to form a funnel-like array.

In any embodiment, the plurality of holes of the alignment guide may be configured such that the electrodes are held at a variety heights relative to the alignment guide (for example, by providing a first group of holes of a first diameter, and at least a second group of holes of a second diameter) such that the electrodes are arranged in a non-planar array, or such that they are arranged in a planar array, the plane of the planar array being angled relative to the plate of the alignment guide.

In any embodiment, except those in which the electrodes are fixed to the alignment guide in use by clamping or any other means, the alignment guide may be removed from the electrode assembly during manufacture of the electrode assembly. For example, the alignment guide may be removed after the electrodes are electrically connected and/or fixed to the base. In use, the electrode assembly may therefore comprise a base and a plurality of electrodes as described herein, in the absence of the alignment guide.

In any embodiment, each hole in the alignment guide may be in the form of a through hole (i.e. an aperture) or a blind hole (i.e. a recess).

Each hole may be configured (sized) to locate the electrode or electrodes received therein in at least a first direction in the plane of the alignment guide. Each hole may be configured (sized) to locate the electrode or electrodes received therein in at least at least two perpendicular directions in the plane of the alignment guide.

Each hole of the alignment guide may be circular or square. Alternatively, each hole of the alignment guide may be a slot or trench, optionally a rectangular slot or trench. In any embodiment, each hole of the alignment guide may be sized such that a width perpendicular to a longitudinal axis of the hole or maximum diameter of the hole is smaller than the diameter of the electrode received therein.

In embodiments in which the holes of the alignment guide are in the form of elongate slots or trenches, the plurality of holes of the alignment guide may be arranged such that they are parallel to each other, such that a longitudinal axis of each hole is parallel to the longitudinal axis of each other hole of the plurality of holes. In embodiments in which the electrodes are cylindrical and the holes are elongate slots or trenches, the longitudinal axis of each electrode may therefore be parallel to the longitudinal axis of each other electrode of the plurality of electrodes. The use of holes in the form of slots or trenches and/or cylindrical electrodes may reduce the number of components required to produce the electrode assembly and reduce complexity of manufacture, while maintaining simplified and accurate alignment of the electrodes.

In embodiments in which the holes of the alignment guide are in the form of elongate slots or trenches, a second alignment guide may be provided. The second alignment guide may be arranged in use such that the longitudinal axes of its holes are perpendicular to the longitudinal axes of the holes of the first alignment guide. In such embodiments, the holes may each be sized to receive a single spherical electrode across their width and a plurality of spherical electrodes along their length (i.e. along the elongate length of the hole), or the each of the holes may be sized to receive a single electrode. One of the first alignment guide and the second alignment guide may be the base. The base and either the first or second alignment guide may be attached or unitary (for example, as in the embodiments shown in FIG. 7 and FIGS. 9-10). The base may be comprise a plurality of holes configured to accurately align the electrode(s) received therein in at least one direction. The plurality of electrodes may clamped between the first alignment guide and the second alignment guide. In this embodiment, a plurality of spherical electrodes may be aligned in two directions using a reduced number of holes (as compared to providing a separate hole for each electrode), which may allow for improved accuracy in manufacture of the holes, and reduced complexity of the alignment guide.

In embodiments in which each hole of the alignment guide is configured to receive a single electrode, for example any embodiment in which the holes are circular or square, the plurality of holes of the alignment guide may be configured in an offset grid pattern (i.e. in rows in a first direction and offset in a second direction) to thereby align the electrodes in an offset grid array. Alternatively, the plurality of holes may be configured in a orthogonal grid pattern (i.e. in rows in two orthogonal directions) to thereby align the electrodes in an orthogonal grid pattern.

In any embodiment a rim of each hole of the plurality of holes of the alignment guide may may be chamfered or otherwise recessed, for example the rim may be countersunk and/or stepped. By chamfering or otherwise recessing the rim of each hole, the alignment guide may facilitate the electrodes moving into the holes and/or self-aligning during assembly. The geometry of the chamfer or other recess may be selected to limit surface contact between the electrode and the insulator. The alignment guide may therefore be configured to limit RF heating effects in the electrode assembly. In any embodiment in which the alignment guide and the base are arranged on opposite sides of the electrode, a widest diameter or width of each hole may be arranged on a face of the alignment guide arranged proximal to the base. In embodiments in which the alignment guide and base are arranged on a same side of the electrode, a widest diameter or width of each hole may be arranged on a face of the alignment guide arranged distal to the base. In embodiments in which the alignment guide and base are arranged on a same side of the electrode, a widest diameter or width of each hole may be arranged on a face of the alignment guide arranged distal to the base. In embodiments in which the alignment guide and base are arranged on a same side of the electrode and the base is arranged between the alignment guide and the equator of the electrodes, a widest diameter or width of each hole may be arranged on a face of the alignment guide arranged proximal to the base.

In any embodiment, the alignment guide and the base may be separate components. In any embodiment in which the alignment guide and base are arranged on a same side of the electrode, the alignment guide may be unitary with or arranged in contact with the base. Such embodiments may provide a simpler assembly process and reduce possible alignment errors (e.g. between the base and the alignment guide), and may allow for simplified repair as a separate alignment tool is not required. The base may be a PCB. The base may be the alignment guide, or the alignment guide may be formed from an upper layer of the base. Alternatively, the alignment guide 310 may be adhered or laminated onto the base 330. In embodiments in which the alignment guide and base are the same component, or the alignment guide is a part of or adhered or laminated to the base, the electrical connections to the base may be arranged in/formed by the chamfered portions of the plurality of holes.

### Assembly

In the electrode assembly of any embodiment, the plurality of electrodes of any embodiment may be used to define quadrupolar channels, or RF surfaces. The RF surface of the electrode assembly may comprise at least 2 electrodes (for example, such that a first and second electrode assemblies may be arranged to form a quadrupole), at least 4 electrodes or at least 10 electrodes. The RF surface of the electrode assembly may comprise up to 100 electrodes or up to 10000 electrodes. For example, an electrode assembly may define comprising at least 1000 electrodes and may measure 0.5×0.5 m in size.

In the electrode assembly, the alignment guide and base may be arranged on opposite sides of the electrode such that the electrodes can be held in place by clamping between the alignment guide and base. For example, in embodiments in which the electrodes are spherical or cylindrical, the equator of each electrode may be positioned between the alignment guide and the base. Arranging the alignment guide and base on opposite sides of the electrode may comprise positioning the widest part (equator) of each electrode (as measured parallel to the plane of the array of electrodes) between an electrode-alignment guide contact point (i.e. a point at which the electrode contacts the alignment guide) and an electrode-base contact point, such that the electrode may be clamped therebetween. In such embodiments, one of the base or the alignment guide may extend to or beyond the equator of the electrode towards the other of the base or the alignment guide.

In embodiments in which the alignment guide and base are arranged on opposite sides of the electrode, the holes of the alignment guide may be either apertures or recesses.

Alternatively, the alignment guide and base may be arranged on a same side of the equators of the electrodes. In such embodiments one of an electrode-alignment guide contact point and an electrode-base contact point may be arranged between the equators of the electrodes and the other of the electrode-alignment guide contact point and the electrode-base contact point. The one of the alignment guide and the base which is proximal to the equators may extend to or beyond the equators of the electrodes towards the ion channel. The electrodes may be fixed to the base by mechanical or other means, for example using solder, fasteners, clips or adhesive. The holes of the alignment guide may be through holes, wherein either i) the alignment guide may be arranged between equator of the electrode and the plate, or ii) the plate may be arranged between the equator of the electrode and the alignment guide, the plate comprising a plurality of apertures for receiving the plurality of electrodes. Alternatively, the holes of the alignment guide may be recesses and the plate may be arranged between equator of the electrode and the alignment guide, the plate comprising a plurality of apertures for receiving the plurality of electrodes.

In embodiments in which the alignment guide and base are arranged on a same side of the electrode, the alignment guide and/or plate may be configured such that at least part of each electrode protrudes through the holes of one of the alignment guide or base towards the other of the alignment guide or base. For example, the thickness may be smaller than a radius (or depth from the equator in a direction perpendicular to the plane of the alignment guide) of the electrodes and/or the dimensions of the chamfering or hole may be selected based on the size of the electrode to allow at least part of the electrode to protrude.

In any embodiment, the alignment guide and/or base may be configured such that at least part of each electrode protrudes from whichever of the alignment guide and the base is to be arranged proximal to the ion channel in use i.e. each electrode should protrude into the ion channel (ion confinement region) relative to the insulating base or alignment guide. The apparatus of the disclosure may therefore avoid or reduce charging and contamination effects of ions striking insulation material. The thickness of the alignment guide (in a plane perpendicular to the plane of the alignment guide) and dimensions (for example, a width, diameter and/or depth) of each hole and/or chamfer may be configured based on the dimensions of the electrode to allow at least part of the electrode to protrude. The electrodes may protrude into the ion channel by a distance of at least the width of the unmetallized area of the base or alignment guide surface between the electrodes, or at least two times or at least three times the width of the unmetallized area.

For example, in embodiments in which one of the alignment guide or plate is arranged between the equator of the electrode and the ion channel the thickness (in a plane perpendicular to the plane of the alignment guide) of the alignment guide or plate may be smaller than a radius of the electrodes (or a largest dimension of the electrode extending from the equator of the electrode in a dimension perpendicular to the plane of the alignment guide) to allow at least part of the electrode to protrude from the alignment guide or plate in the required dimension.

In embodiments in which the alignment guide and base are arranged on opposite sides of the electrode, the thickness of the alignment guide may be less than a radius of the electrode (or depth of the electrodes in a direction perpendicular to the plane of the alignment guide) and the holes and chamfers/recesses may be sized such that a face of the alignment guide proximal to the plate is adjacent to the equator of the electrodes. For example, a spherical electrode may have a 2 mm radius, such that the electrode may protrude by 1 mm from a 1 mm thick alignment plate. Alternatively, the alignment guide may have a total thickness that is greater than the radius of the electrodes (or depth of the electrodes from their equators in a direction perpendicular to the plane of the alignment guide), the thickness of the alignment guide extending from the equator of the electrode towards the ion channel being less than the radius of the electrodes (or depth of the electrodes from their equators in a direction perpendicular to the plane of the alignment guide). Alternatively, the holes of the alignment guide may be sized and chamfered/recessed such that their widest portion is arranged on a face of the alignment guide adjacent to the base, the widest dimension of the holes being larger than the diameter (or maximum width) of the electrode such that the alignment guide may extend beyond the equator of the electrodes towards the base. In this example, the thickness of the alignment guide may be the same as or greater than the radius (or depth of the electrodes in a direction perpendicular to the plane of the alignment guide) of the alignment guide, the holes and chamfers/recesses being dimensioned such that the portion of the alignment guide extending from the equator of the electrode to a face of the alignment guide arranged distal to the plate is less than the radius of the electrode (or a largest dimension of the electrode extending from the equator of the electrode in a dimension perpendicular to the plane of the alignment guide), to allow the electrode to protrude from the alignment guide in a direction away from the plate. In this embodiment, the thickness of the alignment guide may be selected such that the electrodes do not protrude from the alignment guide towards the base, and protruding electrical contacts, for example spring contacts, may be provided extending from the base to the electrodes for electrically connecting the electrodes to the base.

In any embodiment auxiliary DC electrodes may be provided between the holes of the alignment guide or the base, for example by printing auxiliary electrodes onto an alignment guide or base formed from PCB. The auxiliary DC electrodes may be provided on the surface of the electrode assembly which is proximal to the ion channel. In use, auxiliary DC electrodes may be used to provide DC gradients, or low frequency travelling waves, to move ions across the RF surface. In embodiments in which the holes of the alignment guide or base are in the form of elongate slots or trenches, elongate auxiliary DC electrodes may be arranged between and aligned with the holes.

In use, a DC gradient or low frequency travelling waves may be applied using the auxiliary DC electrodes to move ions across the RF surface of the electrode assembly.

The arrangement of the electrodes in the alignment guide may be configured to provide spacing between the RF electrodes and the DC electrodes and therefore mitigate the risk of contamination failure.

In embodiments having spherical or cylindrical electrodes, field penetration of the auxiliary DC electrodes may vary with the curvature of the electrode. To address this, auxiliary DC electrodes may be provided, having varying widths configured to match the filed penetration to the centre. Alternatively, the bearings may be machined after arrangement in the alignment guide to form a planar top surface, for example using wire erosion. Alternatively, a portion of the electrodes of the plurality of electrodes may be supplied with DC voltage, the DC electrodes being arranged between the electrodes being provided with an RF voltage. Further alternatively, mixed DC and RF signals may be applied to the plurality of electrodes in use.

### Ion Guide

Any electrode assembly of the present disclosure may form one layer of an ion guide (for example, for use in mass spectrometry), the plurality of electrodes forming an RF surface of the ion guide. The ion guide may be a planar ion guide.

Any ion guide of the present disclosure may comprise a first electrode assembly according to present disclosure arranged opposite an opposing element comprising one or more of:
a second electrode assembly according to the present disclosure (the second electrode optionally being of the same configuration as the first electrode assembly and/or being inverted relative to the first electrode assembly);
a counter electrode; and/or
an opposing printed circuit board.

In any embodiment, the first electrode assembly and the opposing element may be arranged opposite each other and parallel to each other such that they are spaced apart in a direction perpendicular to the plane defined by the electrodes of the first electrode assembly. At least a part of each electrode may protrude from the first electrode assembly in a direction towards the opposing element. The dimensions of the base and/or alignment guide(s) (for example, their thicknesses, hole sizes and dimensions of chamfers or recesses) may be selected based on the dimensions of the electrodes to provide this protrusion.

In any embodiment, the spacing between electrodes of the first electrode assembly and the electrode(s) of the opposing element may be greater than or equal to 2 mm. Optionally, the spacing may be less than or equal to 10 mm to assist with focussing ion distributions downstream apertures.

In any embodiment, the counter electrode may be in the form of a metal plate. Alternatively, the counter electrode may comprise an array of DC electrodes. The counter electrode may be parallel to the first electrode assembly or may be angled relative to the first electrode assembly.

In any embodiment, the ion guide may comprise one or more guard electrodes. The guard electrodes may be provided on or between the electron assembly/assemblies or opposing element. They may be arranged between the alignment plates of the first and second electrode assemblies The guard electrode(s) may act as spacers to define the relative positions of the first electrode assembly and the opposing element. One or more of the guard electrodes may be provided proximal to an edge of the ion guide to prevent or inhibit ion loss through the sides of the ion guide. Alternatively, or in addition, an ion funnel or interface part may be added to the ion guide to shape or direct the ion flow, for example towards a downstream aperture of the ion guide or a mass spectrometer of which it is part.

In use, focussing of the ion distribution in any ion guide according to the present disclosure may be performed by application of wedged DC or RF potentials. For example, these may be applied by applying a DC offset to a subset of the electrodes, the subset being arranged in a diagonal line relative to an ion flow path defined by the ion guide. Alternatively or additionally, one or more wedged, angled or triangular guard electrodes may be provided on the base and/or alignment guide of the electron assembly or assemblies to shape or direct the ion flow through the ion guide.

In any embodiment, the components of the ion guide may be fixed in place using spacers, fasteners, brackets or other suitable frame or fixation elements.

In embodiments comprising a counter electrode or PCB, in use a DC potential may be applied by the counter electrode or PCB to pin ions down onto the RF surface formed by the array of electrodes of the electrode assembly. Additionally or alternatively, in use an axial DC gradient or travelling wave of voltage may be applied using the upper PCB.

A space defined between an RF surface of the electrode assembly and the opposing element may be used as space to admit laser light, electrons, molecular/ion beams or other means of causing ion fragmentation. The ion guide may also be used as a collision or ion mobility cell. In the latter case the signals applied to the array may be set to define a circuitous path for long ion drift times and consequent high ion mobility.

### Methods

In any embodiment of the present disclosure, arranging each electrode of the plurality of electrodes in a hole of the plurality of holes may comprise placing the plurality of electrodes on the alignment guide and causing the alignment guide, the base and/or the electrodes to move such that the electrodes roll, slide or oscillate and thereby move into the holes of the plurality of holes. For example, the alignment guide and/or the base may be tilted, shaken or oscillated to cause the electrodes to move. This may be achieved without individually placing the electrodes in the holes, such that the arrangement of multiple electrodes of the plurality of electrodes happens at the same time.

Alternatively, arranging each electrode of the plurality of electrodes in a hole of the plurality of holes may comprise first arranging each electrode of the plurality of electrodes in a hole of a plurality of holes of the base and causing the base to move such that the electrodes roll, slide or oscillate and thereby move into the through holes of the base. The alignment guide may then be arranged proximal to the base and positioned such that each hole of the plurality of holes of the alignment guide receives one electrode of the plurality of electrodes.

In a further alternative, arranging each electrode of the plurality of electrodes in a hole of the plurality of holes may comprise individually placing each electrode of the plurality of electrodes into a hole of the plurality of holes.

The base may be arranged opposite the alignment guide (i.e. on an opposite side of the electrodes) after the electrodes are arranged in the plurality of holes therein and the electrodes may be clamped between the base and the alignment guide by relative motion of the base and alignment guide. Electrically connecting each electrode of the plurality of electrodes to the base may thereby be carried out simultaneously. Alternatively, the base may be arranged on a same side of the electrode as the alignment guide, before or after the electrodes are arranged in the holes.

In embodiments where the base is arranged on a same side of the electrode as the alignment guide, arranging each electrode of the plurality of electrodes in a hole of the plurality of holes of the alignment guide may comprise placing the plurality of electrodes on the plate and causing the plate and/or electrodes to move such that the electrodes roll, slide or oscillate and thereby move into the holes of the plate. For example, the plate may be tilted, shaken or oscillated to cause the electrodes to move. This may be achieved without individually placing some or a majority of the electrodes in the holes. In these embodiments, arranging each electrode of the plurality of electrodes in a hole of the plurality of holes may occur at the same time as arranging the electrodes in the holes of the base, or may occur after arranging the electrodes in the holes of the base.

In any embodiment, the holes of the alignment guide and/or the base may be formed by machining, for example drilling. Alternatively, holes may be formed by other methods, for example etching, which may may assist in ensuring structural integrity when a large number of holes are required.

In embodiments in which each hole of the plurality of holes of the alignment guide configured to receive a single electrode, arranging each electrode of the plurality of electrodes in a hole of the plurality of holes may comprise arranging a single electrode in each hole of the plurality of holes. For example, a single spherical electrode may be arranged in each circular or square hole, or as single cylindrical electrode may be arranged in each elongate slot or trench.

In embodiments in which each hole of the plurality of holes of the alignment guide is configured to receive a plurality of electrodes, arranging each electrode of the plurality of electrodes in a hole of the plurality of holes may comprise arranging more than one electrode of the plurality of electrodes in the same hole. In such embodiments, the second alignment plate or base comprising a plurality of holes as described above may be arranged opposite the first alignment plate and the electrodes may then be clamped between the first alignment guide and the second alignment guide or base.

In any embodiment, forming the electrode assembly may comprise securing the components together using one or more of spacers, fasteners (e.g. nuts and bolts, mounting screws etc), frame components and/or other suitable components.

The alignment guide, plurality of electrodes and/or base used in the methods of the present disclosure may be any alignment guide and plurality of electrodes described in the present disclosure.

In use, opposing phases of RF voltages may be applied to adjacent electrodes of the plurality of electrodes to generate an RF surface. Typically the RF frequency may be 0.5-4 MHz, for example ˜2 MHz, and the voltages may be from 50-3000 V. For low vacuum ion guides at the base of the Paschen curve, where discharges (electrical breakdowns between electrodes or from an electrode to ground) occur at minimal potential differences, the maximum RF voltage may be reduced to 200 V. By using electrodes having a smooth surface curvature in such ion guides (such as spherical or cylindrical bearings) the risk of discharge may be minimised.

In embodiments in which the plurality of electrodes is arranged in an offset grid or orthogonal grid, for example a grid of spherical electrodes, a first RF voltage RF1 may be applied to a first set of alternate rows of the electrodes, and a second RF voltage may be applied to a second set of alternate rows of the electrodes, for example such that each row to which the first RF voltage is applied is adjacent to at least one row to which the second RF voltage is applied.

In use, travelling waves or DC gradients may be applied across the plurality of electrodes to move ions through the ion guide. In embodiments in which the plurality of electrodes is arranged in an offset grid or orthogonal grid, DC gradients (or T-waves) may be applied in both x and y directions of the grid and adjusted to control the direction of ion motion. DC offsets applied to electrodes in different areas of the array of electrodes may be set or switched to trap or restrict ion movement in one or more directions.

1. An ion guide comprising:
an electrode assembly comprising:
an alignment guide comprising a plurality of holes;
a plurality of electrodes, each electrode of the plurality of electrodes being rotationally symmetrical about at least one axis; and
a base; and
a second electrode assembly or a counter electrode arranged opposite the electrode assembly;
wherein:
each electrode of the plurality of electrodes is electrically connected to the base; and
each electrode of the plurality of electrodes is received in a hole of the plurality of holes.

2. The ion guide of claim 1 wherein the base is planar, the alignment guide is planar, or a combination thereof.

3. The ion guide of claim 1, wherein the base comprises a plurality of electrical contacts for electrically connecting the plurality of electrodes to the base.

4. The ion guide of claim 1 wherein the plurality of electrodes are arranged in a planar array.

5. The ion guide of claim 1 wherein each hole of the plurality of holes is configured to align the electrode or electrodes received therein in a first direction;
wherein the electrode assembly further comprises a further alignment guide configured to align the electrode or electrodes received therein in a second direction, the second direction being perpendicular to the first direction.

6. The ion guide of claim 1 wherein a rim of each hole of the plurality of holes is chamfered, stepped, countersunk, or a combination thereof.

7. The ion guide of claim 1 wherein the base comprises a plurality of holes, wherein each electrode of the plurality of electrodes is received in a hole of the plurality of holes of the base.

8. The ion guide of claim 1 wherein each electrode of the plurality of electrodes is continuously rotationally symmetrical or has a minimum order of rotational symmetry of 4.

9. The ion guide of claim 1 wherein the alignment guide and the base are arranged on opposite sides of the plurality of electrodes, the plurality of electrodes being clamped between the alignment guide and the base.

10. The ion guide of claim 1 wherein the alignment guide, the base, or a combination thereof are configured such that at least part of each electrode protrudes from the alignment guide, the base, or a combination thereof in a direction towards an ion channel at least partially defined by the electrode assembly.

11. The electrode assembly of claim 10 wherein one or more of
a thickness of the alignment guide, the base, or a combination thereof;
dimensions of the holes of the plurality of holes of the alignment guide, the base, or a combination thereof;
dimensions of a chamfer or recess of the holes of the plurality of holes of the alignment guide, the base, or a combination thereof; or
a combination thereof;
are configured based on the dimensions of the plurality of electrodes such that at least part of each electrode protrudes from the alignment guide, the base, or a combination thereof.

12. An electrode assembly for an ion guide, the electrode assembly comprising a plurality of electrodes, each electrode of the plurality of electrodes being spherical.

13. A method of forming an ion guide, the method comprising:
forming an electrode assembly by:
providing an alignment guide comprising a plurality of holes;
providing a plurality of electrodes, each electrode of the plurality of electrodes being rotationally symmetrical about at least a first axis;
arranging each electrode of the plurality of electrodes in a hole of the plurality of holes; and
electrically connecting each electrode of the plurality of electrodes to a base; and
arranging the electrode assembly opposite a second electrode assembly or a counter electrode.

14. The method of claim 13 wherein when arranged in a hole of the plurality of holes, each electrode of the plurality of electrodes is in contact with a periphery of the hole such that movement of the electrode is constrained in at least a first direction by the periphery of the hole.

15. The method of claim 13 wherein each electrode of the plurality of electrodes is spherical or cylindrical.

16. The method of claim 13 wherein arranging each electrode of the plurality of electrodes comprises causing the electrode to roll, slide or oscillate over a surface of the alignment guide or of the base such that the electrode moves into the hole of the plurality of holes.

17. The method of claim 13 wherein electrically connecting each electrode of the plurality of electrodes to the base is carried out simultaneously.

18. The method of claim 13 wherein each hole of the plurality of holes receives a single electrode of the plurality of electrodes.

19. The method claim 13 wherein each hole of the plurality of holes receives more than one electrode of the plurality of electrodes, the plurality of holes being configured to align the plurality of electrodes in a first direction;
wherein the method further comprises providing a further alignment guide configured to align the plurality of electrodes in a second direction, the second direction being perpendicular to the first direction.

20. The method of claim 13 wherein the plurality of electrodes are arranged in a planar array.
